(19) United States
(12) Patent Application Publication
(10) Pub. No.: US 2012/0217134 A1
(43) Pub. Date: Aug. 30, 2012

(54) DEVICE FOR MECHANICALLY DRAWING AND RELEASING PLASTIC CONTAINERS

(76) Inventor: Secondo Lecchini, Fornovo Taro (IT)

(21) Appl. No.: 13/394,027

(22) PCT Filed: Sep. 2, 2010
(86) PCT No.: PCT/EP10/62879

§ 371 Date: May 17, 2012

(30) Foreign Application Priority Data
Sep. 4, 2009 (IT) PR2009A000065

(51) Int. Cl. B65G 19/02; B65G 19/26

(52) U.S. Cl. 198/633

(57) ABSTRACT

The invention falls in the field for transferring empty/full plastic containers provided with a collar or neck ring and, more particularly, it refers to a lever-shaped drawing device acting between the neck ring and the closing thread of the container. Said lever is kept pressed against a sliding channel (3) of the suspended bottles (2) and can retract for not interfering with said area when bottles build up. A substantially semicircular recess (9) partially surrounds the bottle neck where it interferes with the latter. Two levers are overlapped and by two springs (M1,M2) having different rigidities, two working conditions are defined: a first drawing condition and a second building-up condition; said springs allow the lever to draw also heavy containers and at the same time to disengage from the same if, along the path, there are other building up containers.

### FIELD OF THE INVENTION

It is an object of the present invention a device for mechanically drawing, in a suspended condition, plastic containers provided with a collar and, particularly, the invention relates to a device for drawing each bottle, shaped as a lever and acting between the collar ring and the closing thread of the container, by a substantially semicircular recess partially surrounding the bottle neck in the interference area with the same. The lever is kept pressed toward a sliding channel of the suspended bottles and can retract for not interfering with said area when bottles build up.

In the following description, reference will be made to bottle-like plastic containers, but the invention can also be used for transporting preforms or any plastic containers provided with a collar, called, by a person skilled in the art, neck ring.

### STATE OF THE ART

In bottling plants processing plastic bottles, there are two transporter for transporting empty bottles across the plant, a mechanical transporter and a pneumatic one.

The pneumatic transporter has the disadvantage of handling huge quantities of air and therefore it fouls the containers. Moreover, it is noisy and necessitates a high installed power with a consequent high energy consumption. In addition, the pneumatic transport is not adapted to transport small containers, such as the preforms.

The present invention refers to a mechanical-type transport.

The same applicant is also the holder of a similar application regarding a mechanical device for drawing empty plastic containers provided with a collar, in a suspended condition, wherein it is provided a powered chain located alongside of and parallel to the conveying channel; a plurality of plates uniformly distributed and integral to the chain; a plurality of shaped levers hinged to each corresponding plate and adapted to interfere with the conveying channel by a spring element capable of maintaining each lever pressed against the conveying channel.

In an operative condition, the recess of the lever, by the action of the spring, engages the container and draws it by the chain; in case of building up bottles along the sliding channel, the drawing device is dislodged by the bottles piling up outside the channel area, this action disengages the container and stops the drawing step.

The disadvantages of the above device comprise the impossibility of optimally operating under both the conditions with a single spring as it is known hitherto, because during the drawing step, a too rigid spring, which would allow to draw also full and heavy bottles, is an hindrance when there is a bottles building-up: the lever aims to exert a force on the building-up by causing shocks against the other bottles due to the pressure of the rigid spring; on the contrary, a yielding spring would allow an optimal disengagement but would be not capable of drawing full and heavy bottles/containers, particularly along uphill advancing lengths.

### DISCLOSURE AND ADVANTAGES OF THE INVENTION

The object of the invention consists of providing an improved mechanical device for drawing plastic containers provided with a collar and in a suspended condition, which overcomes the abovementioned disadvantages. The device must operate in both the drawing and releasing steps during a possible building-up in the drawing channel.

Particularly, the new device comprises two springs having different rigidities and acting on different components belonging to the device and more precisely the first one acts on the end part of the recess and the other one acts on the initial part (at the hinge point); said two springs, arranged in this way, allow the device to conveniently operate under both the conditions, that is, for drawing heavy containers and at the same time for easily disengaging from the same when there are building up containers along the path.

Said objects and advantages are fulfilled by the drawing device, object of the present invention, that is characterized for what is cited in the following claims.

### BRIEF DESCRIPTION OF THE INVENTION

These and other characteristics will be better pointed out by the following description of some of its illustrated embodiments, as a non limitative example in the attached drawings.

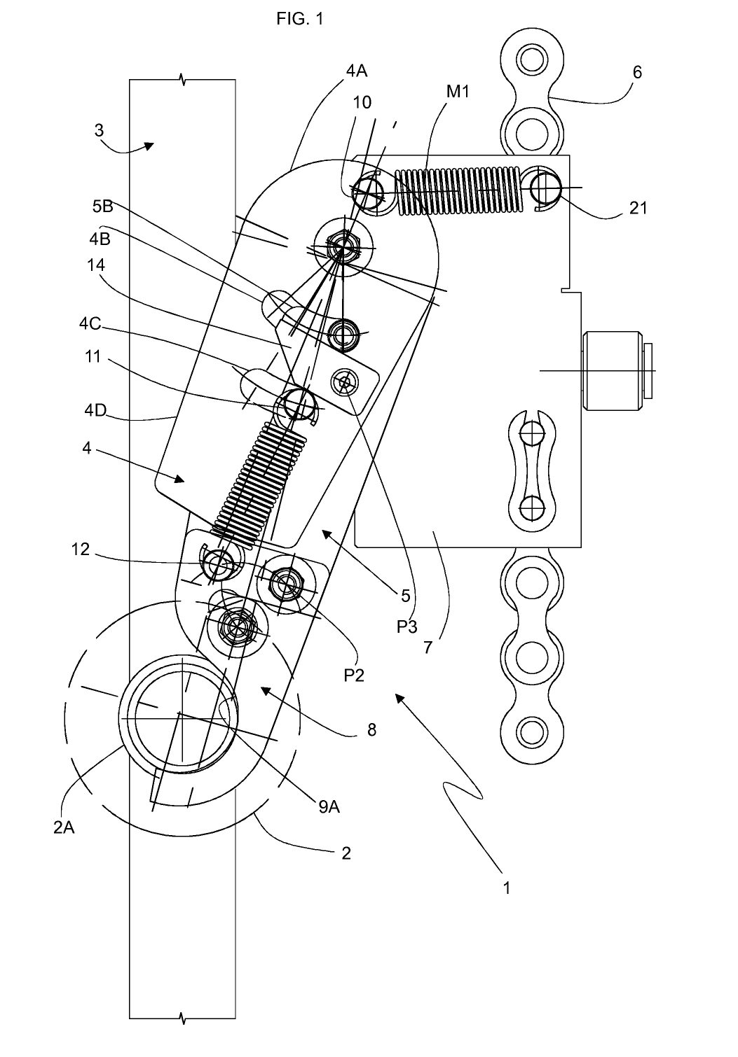

FIG. 1 shows the device in a drawing condition,

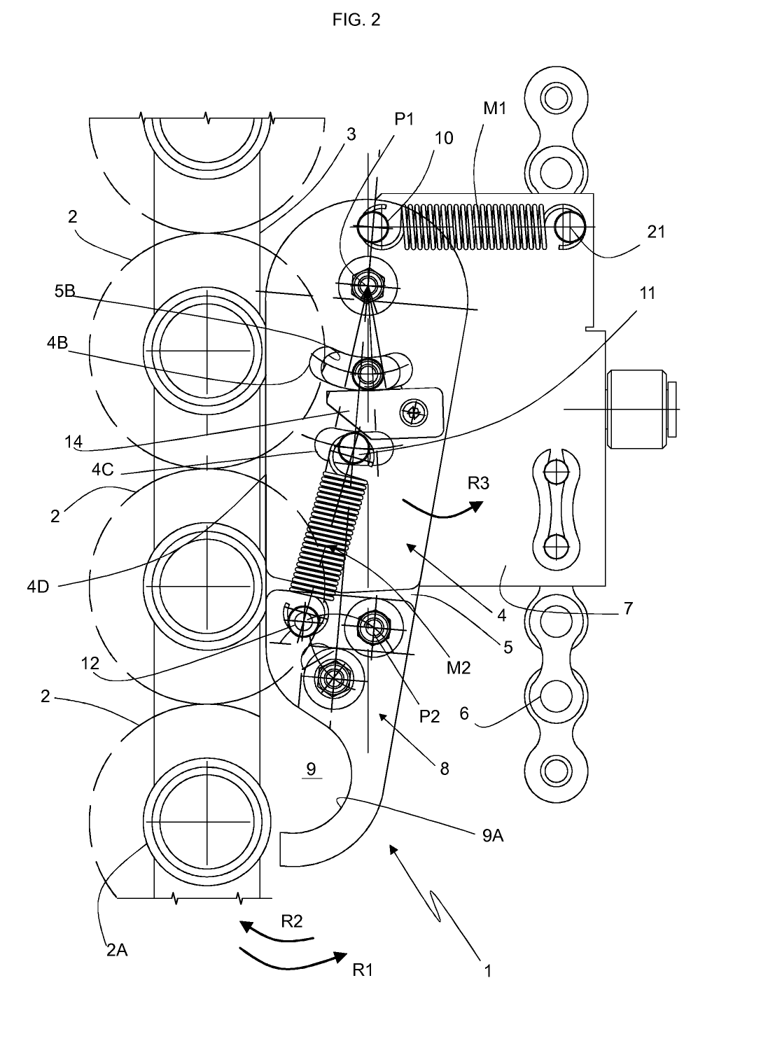

FIG. 2 shows the device in an building-up condition.

### DESCRIPTION OF THE INVENTION

For the features of the invention described in the following, its application will be advantageous both to empty and full containers/bottles.

Referring particularly to FIGS. 1 and 2, 1 generally shows a device for mechanically drawing plastic containers 2 and/or preforms, of the type provided with a collar in a suspended condition.

The figures show two plan views and the containers 2 are carried along a conveying guide or channel 3 (a schematic channel or guide) and are suspended by their neck; the cross size of the channel 3 is adapted to allow the container neck, and not the neck ring 2A or collar of the same, to pass through.

Drawing means, such as a chain 6, slide parallelly to the guides, (the chain is driven by driving and operating means, not shown).

A plurality of plates 7, of which only one is shown, are fixed to said chain 6, to which is connected the inventive drawing device hinged at a pivoting point P1 on the same plate 7.

More particularly, device 1 comprises two levers and 5 overlapped and hinged to said pivoting point P1; levers 4 and 5 have different lengths, but one, lever 4 in the shown example, is shorter than the other.

Levers 4 and 5 have the same shape, that is, when they are overlapped they have a single outline, as shown in FIG. 2; the only perceivable difference is that lever 5 longitudinally projects and for said length it is possible to observe the presence of a gripping finger 8 movable with respect to said lever 5 because it is pivoted to a hinge point shown at P2.

Said hinge point P2 is located on the chain side, while on the other side, finger 8 has a recess 9 having a substantially semicircular outline 9A and shaped in order to partially surround the neck 2 of the bottle on the collar or neck ring 2A, in the interference area with the same and to draw the bottle along the channel 3 when are complied the operative conditions described in the following.

The shortest lever 4 has, on the portion of its outer end, in other words, between the pivoting point P1 and the outline semicircular edge 4A, a hooking point (in the specific example a pawl 10 projecting from the plane) for the end of a first spring M1 connecting said pawl 10 to a corresponding fixed point 21 on the plate 7.

Said spring M1 is a traction spring, that is, it withdraws the hooking point 10 to the chain 6 taking it, without obstacles such as other bottles in the channel 3, to a predetermined angular position (the position shown in FIG. 1) corresponding to the position of the minimum energy of the spring M1 itself; in said position, the lever 4, and also lever 5, occupy the space defined by the channel 3, obviously they do not interfere with it but they stay above it.

Lever 4 is more slanted than lever 5 and this occurs due to two guides with slots 4B and 5B arranged as a circumference arc and overlapped, the slots receiving a pin P3 fixed to the plate 7; slot 4B of the lever 4 covers a longer angular length which causes the greater angling due to the tension of spring M1. The purpose of pin P3, together with a stop 14 advantageously located on lever 4, and the presence of springs M1 and M2, allows the device to efficiently operates both during the drawing and building-up steps, as described below.

As said, device 1 comprises a further spring M2 having a rigidity greater than the above described spring M1.

Spring M2 operates inside the device, that is, connects lever 5 to finger 8 by two stop points indicated at 11 and 12 in the figures: pin 11 projects from lever 4 and exit trough a slit or slot 4C of the lever 4, while the pin 12 projects from finger 8.

The function of the spring M2 consists of returning the finger 3 towards the channel 3, by forming a moment R3 opposite to the one necessary for releasing the finger 8 from the bottle neck (said moment is indicated at R1 in the figure).

The stop 14 is registered and blocked on the lever 4 in order to positions, when spring M1 has the minimum energy, that is, when, as shown in FIG. 1, the channel is empty and spring M1 is uncompressed, between the pin P3 and pin 11 described before.

During the drawing step with a bottle or preform hooked in the recess 9 of finger 8, the system acts as a rigid body, and spring M2 having a greater rigidity, advantageously keeps finger 8 attached the container/bottle or preform; it follows that by locating a spring having a suitable rigidity, it is possible to draw also high loads, without running the risk of losing them during the travel.

When a build-up of bottles forms in the channel 3, it is convenient to have a fast removal of the device, and in this case spring M1, less rigid than spring M2, starts to operate.

When lever 4 meets a building-up bottle/container (or preform), it easily rotates around the pivot P1 due to the smaller rigidity of the spring M1, according to the rotation direction R3 and it locates its side 4D parallelly to channel 3; during said rotation, the stop 14 disengages from pins P3 and 11, releasing the previously formed engagement and allowing the disengagement of the hooking finger from the associated bottle. In other words, lever 4 acts to block the lever 5 and finger 8, by preventing the disengagement also under high loads.

By the present invention, both empty and full containers (anyway heavy) can be transported, without preventing their optimal releasing during the building-up step.

1. Device (1) for mechanically drawing and releasing plastic containers (2), either empty or filled, and/or preforms; said containers (2) or preforms of the type comprising a collar (2A) adapted to rest on a conveying channel (3); a powered chain (6) arranged alongside and parallelly to the conveying channel (3) draws said device (1) which is hingedly supported at a pivoting point (P1) to a plate (7) integral with the chain (6), a recess (9) being shaped such as to partially surround the bottle neck (2) above the collar or neck ring (2A), in the interference area therewith and draw the latter along the channel (3) characterized in that it comprises
a. two levers (4) and (5) being overlapped and hinged at said hinge point (P1), lever (5) being longer than lever (4) and along said length a gripping finger (8) is pivoted to said lever (5) at a hinge point (P2);
b. two springs (M1) and (M2) having different rigidities from each other, the spring (M2) being more rigid than the spring (M1); spring (M1) being suitable to carry, under minimum energy conditions, the lever (4) proximate to the space defined by the channel (3); the spring (M2) operating within the device (1), connects the lever (5) to the finger (8) by means of two corresponding stop points (11, 12),
c. a stop (14) which is registered with and locked to the lever (4) such as to be inserted, under minimum energy conditions of the spring (M1), between a fixed pin (P3) on the plate (7) and the stop point (11) of the lever (5); said fixed pin (P3) passing through corresponding slots (4B) and (5B) which are semicircularly arranged on the levers (4, 5),
during the drawing step with the container (2) being coupled to the recess (9) of finger (8), the device operates as a rigid body by means of the action of the stop (14) which is in the locking position;
when the lever (4) meet a row of building up containers along the channel (3), it releases the stop (14) by overcoming the action of the spring (M1), and positions its flank (4D) parallelly to the channel (3), and the lever (5) and finger (8) can release the container (2) being drawn.

2. Drawing device (1) according to claim 1, characterized in that said levers (4) and (5) have the same shape in an overlapped configuration, except for the portion longitudinally projecting from lever (5) on which the finger (8) is pivoted.

3. Drawing device (1) according to claim 1, characterized in that said levers (4) and (5) each comprise a slot (4B) and (5B); said slots being semicircularly arranged and overlapped, and receiving the fixed pin (P3) on the plate (7); the slot (4B) of lever (4) covers a greater angular length, thereby resulting in the greater angling caused by the tension of spring (M1).

4. Drawing device (1) according to claim 1, characterized in that said spring (M1) connects the lever (4) to the plate (7) by being hooked to a pawl (10) and a corresponding fixed point (21) on the plate (7); said pawl (10) being located between the pivoting point (P1) and the semicircular edge (4A) of the lever (4).

5. Conveyor system for containers of the type comprising a plurality of mechanical drawing devices (1) according to claim 1.
